(19) United States
(12) Patent Application Publication
(10) Pub. No.: US 2020/0234843 A1
(43) Pub. Date: Jul. 23, 2020

(54) ELECTRICALLY CONDUCTIVE PASTE

(71) Applicant: Noritake Co., Limited, Nagoya-shi, Aichi-ken (JP)

(72) Inventor: Kazuyuki Okabe, Miyoshi-shi, Aichi-ken (JP)

(21) Appl. No.: 16/650,183

(22) PCT Filed: Sep. 10, 2018
(86) PCT No.: PCT/JP2018/033340

§ 371 Date: Mar. 24, 2020

(30) Foreign Application Priority Data
Oct. 10, 2017 (JP) 2017-196770

(51) Int. Cl. H01B 1/22; H01G 4/008; H01G 4/12; H01G 4/30

(52) U.S. Cl. CPC H01B 1/22; H01G 4/30; H01G 4/12; H01G 4/008

(57) ABSTRACT

The present invention provides an electrically conductive paste including inorganic components and organic components. The inorganic components include an electrically conductive powder and a dielectric powder. The organic components include a dispersing agent and a vehicle. The dispersing agent includes a dispersing agent having an acid value. When the total acid value of the organic components per unit mass of the electrically conductive paste is taken as X (mg KOH) and the total specific surface area of the inorganic components per unit mass of the electrically conductive paste is taken as Y (m²), the X and the Y satisfy the following formula: 5.0×10⁻²≤(X/Y)≤6.0×10⁻¹.

### TECHNICAL FIELD

The present invention relates to an electrically conductive paste. More specifically, the present invention relates to an electrically conductive paste that is suitable for forming an internal electrode layer of a multilayer ceramic electronic component.

The present application claims priority on the basis of Japanese Patent Application No. 2017-196770, which was filed on 10 Oct. 2017, and the entire contents of that application are herein incorporated by reference.

### BACKGROUND ART

In the production of electronic components such as multi-layer ceramic capacitors (MLCC), it is common to use a method comprising applying an electrically conductive paste to a substrate so as to form a conductor film, and then firing the conductor film so as to form an electrode layer.

In one example of a method for producing a MLCC, a plurality of unfired ceramic green sheets, each of which contains ceramic powder and a binder, are first prepared. Next, conductor films are formed by applying an electrically conductive paste to the plurality of ceramic green sheets and drying the paste. Next, the plurality of conductor film-equipped ceramic green sheets are laminated and pressure bonded. These are then integrated and sintered by being fired. An external electrode is formed on both end surfaces of the fired composite material. Thus produced is a MLCC having a structure in which a dielectric layer including a ceramic and an internal electrode layer including a sintered body of the electrically conductive paste are alternately laminated many times. For example, Patent Literature 1 discloses an electrically conductive paste used for forming an internal electrode layer of such a MLCC.

### CITATION LIST

### Patent Literature

Patent Literature 1: Japanese Patent Application Publication No. 2016-33900

### SUMMARY OF INVENTION

As electronic devices have become smaller and higher in terms of performance in recent years, there have been demands for electronic components fitted to electronic components to become further smaller, thinner and denser. In order to meet these demands, the thickness of single layer components such as dielectric layers and internal electrode layers in, for example, chip type MLCCs has been reduced to the sub-micron to micron level, and the number of layers in such components now exceeds 1000. In such MLCCs, slight unevenness on the surface of any conductor film leads to strain in a multilayer structure, which can be a cause of defects such as shorting defects. Therefore, it is necessary to form a conductor film having high surface smoothness when producing this type of multilayer ceramic electronic component.

With such circumstances in mind, the present invention has an object to provide an electrically conductive paste capable of forming a conductor film having excellent surface smoothness.

The inventor of the present invention carried out investigations from various perspectives using a plurality of conductor films having different surface smoothness properties. As a result, it was found that conductor films having insufficient surface smoothness show phase separation between an inorganic component and an organic component. Here, the inventor of the present invention considered increasing the affinity between the inorganic component and the organic component and suppressing phase separation in a conductor film by adjusting an acid value of the organic component and a property of the inorganic component in an electrically conductive paste. The inventor of the present invention has completed the present invention following further diligent study.

The present invention provides an electrically conductive paste for forming a conductor film. The electrically conductive paste includes inorganic components and organic components. The inorganic components include an electrically conductive powder and a dielectric powder. The organic components include a dispersing agent and a vehicle. The dispersing agent includes a dispersing agent having an acid value. When the total acid value of the organic components per unit mass of the electrically conductive paste is taken as X (mg KOH) and the total specific surface area of the inorganic components per unit mass of the electrically conductive paste is taken as Y (m²), the X and the Y satisfy the following formula: 5.0×10⁻²≤(X/Y)≤6.0×10⁻¹.

According to the features mentioned above, affinity between the inorganic components and organic components can favorably increases as a result of acidic groups in the organic components acting on the surface of particles of the inorganic components. As a result, it is possible to improve the stability and integrity of the electrically conductive paste as a whole. According to the features mentioned above, it is also possible to surpress the viscosity of the electrically conductive paste from becoming excessively high, thereby achieving favorable self-leveling properties. As a result of the effects mentioned above, phase separation is ameliorated and high surface smoothness can be achieved in a conductor film obtained using this electrically conductive paste.

The “acid value” is the content (mg) of potassium hydroxide (KOH) required to neutralize free fatty acids contained in a unit sample (1 g). The units for acid value are mg KOH/g.

The “total acid value X (mg KOH) of the organic components” can be calculated per unit mass (100 g) of the electrically conductive paste from the following formula (1): X (mg KOH)=Σ[acid value (mg KOH/g) of each organic component x content (mass %) of each organic component relative to the electrically conductive paste as a whole]. Values measured using a potentiometric titration method in accordance with JIS K 0070:1992 can be used as the acid values of the organic components mentioned above.

In addition, the “total specific surface area Y (m²) of the inorganic components” can be calculated per unit mass (100 g) of the electrically conductive paste from the following formula (2): Y (m²)=E[specific surface area (m²/g) of each inorganic component x content (mass %) of each inorganic component relative to the electrically conductive paste as a whole]. BET specific surface area measured using a nitrogen gas adsorption method and analyzed using the BET method can be used as the specific surface area of each inorganic component.

In a preferred aspect of the electrically conductive paste disclosed here, the inorganic components have a number-based average particle diameter of 0.3 μm or less, as determined by electron microscope observations. With this configuration, it is possible to advantageously provide a conductor film having particularly excellent surface smoothness, that is, a conductor film having an arithmetic mean roughness Ra of the conductor film of 5 nm or less (0.005 μm or less).

In a preferred aspect disclosed here, the amount of the dispersing agent is 3 mass % or less relative to 100 mass % as the overall amount of the electrically conductive paste. By keeping the proportion of the dispersing agent low, the dispersing agent is readily burned off during firing. With this configuration, it is possible to advantageously provide an electrode layer having excellent electrical conductivity because the dispersing agent is unlikely to remain in the electrode layer after firing.

In a preferred aspect disclosed here, the electrically conductive powder is at least one of nickel, platinum, palladium, silver and copper. With this configuration, it is possible to advantageously provide an electrode layer having excellent electrical conductivity.

In a preferred aspect disclosed here the electrically conductive paste is used in order to form an internal electrode layer of a multilayer ceramic electronic component. In multilayer ceramic electronic components, slight unevenness in a conductor film may be a fatal problem and lead to defects such as shorting defects. Therefore, this electrically conductive paste can be advantageously used in order to form an internal electrode layer of a multilayer ceramic electronic component.

### BRIEF DESCRIPTION OF DRAWINGS

FIG. 1 is a cross-sectional view that schematically illustrates a multilayer ceramic capacitor according to one embodiment.

FIG. 2 is a graph that shows the relationship between the value of X/Y and the value of Ra.

### DESCRIPTION OF EMBODIMENTS

Preferred embodiments of the present invention will now be explained. Matters which are essential for carrying out the invention (for example, matters relating to methods for preparing the electrically conductive paste and methods for forming the conductor film) and which are matters other than those explicitly mentioned herein (for example, matters relating to compositions of the electrically conductive paste) are matters that a person skilled in the art could understand to be matters of design on the basis of the prior art in this technical field. The present invention can be carried out on the basis of the matters disclosed herein and common general technical knowledge in this technical field.

In the explanations given below, a “conductor film” means an unfired film-shaped body obtained by applying an electrically conductive paste to a substrate and then drying at a temperature that is not higher than the boiling point of a dispersing agent contained in the electrically conductive paste (for example, 100° C. or lower). In addition, a numerical range indicated by “A to B” herein means not lower than A and not higher than B.

<<Electrically Conductive Paste>>

The electrically conductive paste disclosed here (hereinafter referred to simply as “paste” on some occasions) is used in order to form a conductor film. Components in the electrically conductive paste disclosed here are divided broadly into inorganic components and organic components. The inorganic components include at least an electrically conductive powder (A) and a dielectric powder (B). The organic components include at least a dispersing agent (C) and a vehicle (D). The term “paste” used herein is a term that encompasses a composition, an ink and a slurry. Each component will now be explained.

<(A) Electrically Conductive Powder>

The electrically conductive powder (A) contained in the paste is a component for imparting electrical conductivity to an electrode layer after firing. The type etc. of the electrically conductive powder (A) is not particularly limited, and one or two or more types of commonly used electrically conductive powder can be used as appropriate according to the intended use of the electrically conductive paste or the like. An electrically conductive metal powder can be given as a preferred example of the electrically conductive powder (A). Specific examples thereof include individual metals, such as nickel (Ni), platinum (Pt), palladium (Pd), gold (Au), silver (Ag), copper (Cu), ruthenium (Ru), rhodium (Rh), iridium (Ir), osmium (Os) and aluminum (Al), and mixtures, alloys, and the like, of these metals.

Although not particularly limited, it is preferable to use a type of metal such that the melting temperature (for example, melting point) of the electrically conductive powder (A) is sufficiently higher than the sintering temperature of the ceramic powder contained in the dielectric layer in the case of applications such as formation of an internal electrode layer of a multilayer ceramic electronic component. Examples of such metals include nickel, platinum, palladium, silver and copper. Of these, nickel and nickel alloys are preferred from the perspectives of being inexpensive and achieving an excellent balance between electrical conductivity and cost.

Properties of the particles that constitute the electrically conductive powder (A), such as the size and shape of the particles, are not particularly limited as long as the particles fit within the minimum dimension in a cross section of an electrode layer (typically the thickness and/or width of the electrode layer). The average particle diameter of the electrically conductive powder (A) (the particle diameter corresponding to a cumulative 50% from the small particle diameter side in a number-based particle size distribution determined on the basis of electron microscope observations; hereinafter defined in the same way) can be selected as appropriate according to, for example, the intended use of the paste or the dimensions (fineness) of an electrode layer. The average particle diameter of the electrically conductive powder (A) is generally several nanometers to several tens of microns, for example 10 nm to 10 μm.

For example, in applications where an internal electrode layer of an ultra-small MLCC is to be formed, the average particle diameter of the electrically conductive powder (A) is preferably smaller than the thickness (the length in the direction of lamination) of the internal electrode layer, and is typically 0.5 μm or less, preferably 0.3 μm or less, and more preferably 0.25 μm or less, for example 0.2 μm or less. When the average particle diameter is the prescribed value or less, a thin conductor film can be stably formed. In addition, it is possible to significantly reduce the arithmetic mean roughness Ra of the conductor film and advantageously suppress this roughness to a level such as 5 nm or less. The average particle diameter of the electrically conductive powder (A) is generally approximately 0.01 μm or more, typically 0.05 μm or more, and preferably 0.1 μm or more, for example 0.12 μm or more. When the average particle diameter is the prescribed value or more, the surface energy of the particles is lowered and aggregation in the paste is suppressed. As a result, self-leveling properties can be further improved. In addition, it is possible to increase the density of the conductor film and advantageously provide an electrode layer having high electrical conductivity and compactness.

The specific surface area of the electrically conductive powder (A) is not particularly limited, but is generally approximately 10 m²/g or less, and preferably 1 to 8 m²/g, for example 2 to 6 m²/g. With this configuration, aggregation in the paste can be favorably suppressed, and the homogeneity, dispersibility and storage stability of the paste can be further improved. In addition, it is possible to more stably provide an electrode layer having excellent electrical conductivity.

The shape of the electrically conductive powder (A) is not particularly limited, but is preferably spherical or approximately spherical. In other words, the average aspect ratio (the average value of the ratio of the short axis relative to the long axis of particles, as calculated on the basis of electron microscope observations) of the electrically conductive powder (A) is generally 1 to 2, and preferably 1 to 1.5. With this configuration, it is possible to maintain a low paste viscosity and improve the handling properties of the paste and improve workability during film formation. In addition, it is possible to improve the homogeneity of the paste.

The electrically conductive powder (A) content is not particularly limited, but if the overall amount of the electrically conductive paste is taken as 100 mass %, the electrically conductive powder content is generally approximately 30 mass % or more, and is typically 40 to 95 mass %, for example 45 to 60 mass %. By falling within the range mentioned above, it is possible to advantageously provide an electrode layer having high electrical conductivity and compactness. In addition, it is possible to improve the handling properties of the paste and improve workability during film formation.

<(B) Dielectric Powder>

The dielectric powder (B) contained in the paste is a component that alleviates thermal shrinkage of the electrically conductive powder (A) during firing of a conductor film. The type etc. of the dielectric powder (B) is not particularly limited, and one or two or more types of commonly used in inorganic material powder can be used as appropriate according to the intended use of the electrically conductive paste or the like. Preferred examples of the dielectric powder (B) include ceramics having a perovskite structure represented by ABO₃, such as barium titanate, strontium titanate, calcium titanate, magnesium titanate, calcium zirconate, bismuth titanate, zirconium titanate and zinc titanate; titanium oxide and titanium dioxide. For example, in applications where an internal electrode layer of a MLCC is to be formed, it is preferable to use the same type of material as the ceramic powder contained in a dielectric layer, typically barium titanate (BaTiO₃). With this configuration, integration between a dielectric layer and an internal electrode layer increases.

The relative dielectric constant of the dielectric powder (B) is typically 100 or more, and preferably 1000 or more, for example 1000 to 20,000.

Properties of the particles that constitute the dielectric powder (B), such as the size and shape of the particles, are not particularly limited as long as the particles fit within the minimum dimension in a cross section of an electrode layer (typically the thickness and/or width of the electrode layer). The average particle diameter of the dielectric powder (B) can be selected as appropriate according to, for example, the intended use of the paste or the dimensions (fineness) of an electrode layer. The average particle diameter of the dielectric powder (B) is generally several nanometers to several tens of microns, for example 10 nm to 10 μm, and is preferably 0.3 μm or less. From the perspective of increasing the electrical conductivity, homogeneity and compactness of an electrode layer, the average particle diameter of the dielectric powder (B) is preferably less than the average particle diameter of the electrically conductive powder (A), and is more preferably 1/20 to ½ of the average particle diameter of the electrically conductive powder (A).

For example, in applications where an internal electrode layer of an ultra-small MLCC is to be formed, the average particle diameter of the dielectric powder (B) is generally several nanometers to several hundreds of nanometers, for example 10 to 100 nm. When this average particle diameter is the prescribed value or less, it is possible to significantly lower the arithmetic mean roughness Ra of a conductor film. In contrast, when the average particle diameter is the prescribed value or more, the surface energy of the particles is lowered and aggregation in the paste is suppressed. As a result, self-leveling properties can be further improved.

The specific surface area of the dielectric powder (B) is not particularly limited, but is typically greater than the specific surface area of the electrically conductive powder (A), and is generally 100 m²/g or less, and preferably 5 to 80 m²/g, for example 10 to 70 m²/g. With this configuration, aggregation of particles can be favorably suppressed, and the homogeneity, dispersibility and storage stability of the paste can be further improved. In addition, it is possible to more stably provide an electrode layer having excellent electrical conductivity.

The dielectric powder (B) content is not particularly limited, but if the overall amount of the electrically conductive paste is taken to be 100 mass %, the dielectric powder content may generally be approximately 1 to 20 mass %, for example 2 to 15 mass %, in applications such as formation of an internal electrode layer of a MLCC. The dielectric powder (B) content relative to 100 parts by mass of the electrically conductive powder (A) is not particularly limited, but is generally approximately 3 to 30 parts by mass, for example 5 to 25 parts by mass. By falling within the range mentioned above, the advantageous effect of the dielectric powder (B) can be advantageously achieved and thermal shrinkage of the electrically conductive powder (A) can be better alleviated. In addition, it is possible to advantageously provide an electrode layer having excellent electrical conductivity.

<(C) Dispersing Agent>

The dispersing agent (C) contained in the paste is a component for dispersing inorganic components (typically the electrically conductive powder (A) and the dielectric powder (B)) in the vehicle (D) so as to advantageously suppress aggregation of particles of the inorganic components. The term “dispersing agent” used herein means compounds in general having amphipathic properties and having a hydrophilic segment and a lipophilic segment, and is a term that encompasses surfactants, wetting and dispersing agents and emulsifying agents.

The type etc. of the dispersing agent (C) is not particularly limited, and one or two or more types of commonly used dispersing agent can be used as appropriate according to the intended use of the electrically conductive paste or the like (however, this excludes preferred examples of a binder (D1) described later). The dispersing agent (C) is preferably burned off when a conductor film is fired (typically in a heating treatment carried out at a temperature of 250° C. or higher in an oxidizing atmosphere). In other words, the boiling point of the dispersing agent (C) is preferably lower than the firing temperature of the conductor film.

The dispersing agent (C) includes a dispersing agent having an acid value (that is, the acid value is greater than the detection lower limit). In the explanations given below, a dispersing agent having an acid value is sometimes referred to as “an acid value-having dispersing agent”. A acid value-having dispersing agent typically has one or two or more acidic groups as hydrophilic groups. Examples of such an acid value-having dispersing agent include carboxylic acid-based dispersing agents having one or two or more carboxyl groups (COO⁻ groups), phosphoric acid-based dispersing agents having one or two or more phosphonic acid groups (PO₃⁻ groups and PO₃²⁻ groups) and sulfonic acid-based dispersing agents having one or two or more sulfonic acid groups (SO₃⁻ groups and SO₃²⁻ groups). Of these, carboxylic acid-based dispersing agents generally have high acid values, and can therefore stably exhibit the advantageous effect of the features disclosed here even when used at a relatively low usage quantity. Examples of carboxylic acid-based dispersing agents include monocarboxylic acid-based dispersing agents, dicarboxylic acid-based dispersing agents, polycarboxylic acid-based dispersing agents and dispersing agents based on partial alkyl esters of polycarboxylic acids.

The acid value-having dispersing agent is a component for adjusting the total acid value X of the organic components. The acid value of the acid value-having dispersing agent may generally be 10 mg KOH/g or more, and preferably 30 mg KOH/g or more, for example 50 mg KOH/g or more. With this configuration, the advantageous effect of the present invention can be favorably exhibited even with low added quantity of the dispersing agent. The upper limit of the acid value of acid value-having dispersing agent is not particularly limited, but generally 300 mg KOH/g or less, and preferably 200 mg KOH/g or less, for example 180 mg KOH/g or less. With this configuration, it is easy to finely adjust the total acid value X of the organic components. It is also possible to suppress affinity for the inorganic components in the paste from becoming excessively high. Therefore, it is possible to suppress an increase in viscosity of the paste and improve the handling properties of the paste and improve workability during film formation. It is also possible to increase the self-leveling properties of the paste and provide a conductor film having a smoother surface.

The dispersing agent (C) may include a non-acid value dispersing agent not having an acid value. A non-acid value dispersing agent means a dispersing agent having an acid value that is not more than the detection lower limit (this varies according to measurement precision, but is generally 0.1 mg KOH/g or less). Examples of non-acid value dispersing agents include amine-based dispersing agents having one or two or more amino groups as hydrophilic groups.

The weight average molecular weight Mw of the dispersing agent (C) (which is measured by means of gel permeation chromatography (GPC), and is a weight-based average molecular weight calculated using a standard polystyrene calibration curve; hereinafter defined in the same way) may generally be less than 20,000, for example approximately 50 to 15,000. When the molecular weight is the prescribed value or more, repulsive forces between particles of the inorganic component increase and the advantageous effect of suppressing aggregation is better exhibited. In contrast, when the molecular weight is the prescribed value or lower, it is possible to improve the self-leveling properties of the paste and provide a conductor film having a smooth surface.

The dispersing agent (C) content is not particularly limited, but if the overall amount of the electrically conductive paste is taken as 100 mass %, the dispersing agent content may generally be approximately 0.01 mass % or more, and is typically 0.05 mass % or more, and preferably 0.1 mass % or more, for example 0.12 mass % or more. By making the proportion of the dispersing agent (C) the prescribed value or more, the advantageous effect achieved by adding the dispersing agent (C) can be better exhibited. The upper limit of the dispersing agent (C) content is not particularly limited, but may generally be 5 mass % or less, and preferably 3 mass % or less, for example 2 mass % or less. By limiting the proportion of the dispersing agent (C) to the prescribed value or less, the dispersing agent is readily burned off during firing. With this configuration, the dispersing agent (C) is unlikely to remain in the electrode layer. Therefore, it is possible to advantageously provide an electrode layer having excellent electrical conductivity. Meanwhile, even in cases where, for example, a thin conductor film is to be formed, it is possible to suppress the occurrence of defects such as pores and cracks in an electrode layer after firing.

The dispersing agent (C) content relative to 100 parts by mass of inorganic components (for example, the total mass of the electrically conductive powder (A) and the dielectric powder (B)) is not particularly limited, but in applications such as formation of an internal electrode layer of an ultra-small MLCC, this content is generally 0.1 to 10 parts by mass, for example 0.3 to 6 parts by mass. With this configuration, even in cases where, for example, an ultrafine inorganic component having an average particle diameter of 0.3 μm or less is contained in the paste, it is possible to advantageously improve the homogeneity, dispersibility and storage stability of the paste while limiting the usage quantity of the dispersing agent (C).

<(D) Vehicle>

The vehicle (D) is a component for dispersing inorganic components, typically the electrically conductive powder (A) and dielectric powder (B) described above. In addition, the vehicle is a component for imparting a suitable viscosity and fluidity to the paste so as to improve the handling properties of the paste and improve workability during film formation. The vehicle (D) may, or may not, have an acid value. The vehicle (D) includes, for example, a binder (D1) and an organic solvent (D2).

<(D1) Binder>

The binder (D1) is a component for imparting adhesive properties to an unfired conductor film so as to tightly bond inorganic components to each other and inorganic components to a substrate that is to support the conductor film. The binder (D1) is preferably burned off when a conductor film is fired (typically in a heat treatment carried out at a temperature of 250° C. in an oxidizing atmosphere). In other words, the boiling point of the binder (D1) is preferably lower than the firing temperature of the conductor film. The type etc. of the binder (D1) is not particularly limited, and one or two or more types of, for example, commonly used organic polymer can be used as appropriate according to the intended use of the electrically conductive paste or the like.

Preferred examples of the binder (D1) include organic polymer compounds such as cellulose-based resins, butyral-based resins, acrylic-based resins, epoxy-based resins, phenolic resins, alkyd-based resins, rosin-based resins and ethylene-based resins. The binder (D1) typically has repeating constituent units. Of these, cellulose-based resins are preferred from perspectives such as excellent combustion degradation properties during firing and environmental considerations.

Examples of cellulose-based resins include cellulose organic acid esters (cellulose derivatives) in which some or all of the hydrogen atoms in hydroxy groups of cellulose repeating constituent units are substituted with alkyl groups such as methyl groups, ethyl groups, propyl groups, isopropyl groups or butyl groups; acyl groups such as acetyl groups, propionyl groups or butyryl groups; methylol groups, ethylol groups, carboxymethyl groups, carboxyethyl groups, and the like. Specific examples thereof include methyl cellulose, ethyl cellulose, hydroxymethyl cellulose, hydroxyethyl cellulose, hydroxypropyl cellulose, hydroxypropylmethyl cellulose, carboxymethyl cellulose, carboxyethyl cellulose, carboxyethylmethyl cellulose, cellulose acetate phthalate and nitrocellulose.

Examples of butyral-based resins include homopolymers of vinyl acetate, and copolymers which contain vinyl acetate as a primary monomer (a component that accounts for 50 mass % or more of all monomers; hereinafter defined in the same way) and also contain a secondary monomer able to be copolymerized with the primary monomer. An example of a homopolymer is poly(vinyl butyral). Specific examples of copolymers include poly(vinyl butyral) (PVB) containing vinyl butyral (a butyral group), vinyl acetate (an acetyl group) and vinyl alcohol (a hydroxy group) as repeating constituent units in the main chain skeleton.

Examples of acrylic-based resins include homopolymers of alkyl (meth)acrylates and copolymers which contain an alkyl (meth)acrylate as a primary monomer and also contain a secondary monomer able to be copolymerized with the primary monomer. Specific examples of homopolymers include poly(methyl (meth)acrylate), poly(ethyl (meth)acrylate) and poly(butyl (meth)acrylate). Specific examples of copolymers include block copolymers containing a methacrylic acid ester polymer block and an acrylic acid ester polymer block as constituent units. The term “(meth)acrylate” used herein is a term that means both acrylate and methacrylate.

The weight average molecular weight Mw of the binder (D1) is generally 20,000 or more, and is typically 20,000 to 1,000,000, for example 50,000 to 500,000. When the molecular weight is the prescribed value or more, the adhesive properties of the binder (D1) increase, and an adhesive effect can be exhibited even when the added quantity of the binder is low. In contrast, when the molecular weight of the binder (D1) is the prescribed value or less, it is possible to maintain a low paste viscosity and improve the handling properties and self-leveling properties of the paste. Therefore, it is possible to further suppress unevenness on the surface of a conductor film.

The binder (D1) content is not particularly limited, but if the overall amount of the electrically conductive paste is taken as 100 mass %, the binder content may generally be approximately 0.1 to 10 mass %, and is typically 0.5 to 5 mass %, for example 1 to 3 mass %. By falling within the range mentioned above, it is possible to improve the handling properties of the paste and workability during film formation and suppress the occurrence of delamination to a high degree. In addition, it is possible to increase the self-leveling properties and provide a conductor film having a smoother surface. The binder (D1) content relative to 100 parts by mass of inorganic components (for example, the total mass of the electrically conductive powder (A) and the dielectric powder (B)) is not particularly limited, but in applications such as formation of an internal electrode layer of an ultra-small MLCC, this content is generally 1 to 10 parts by mass, for example 2 to 5 parts by mass. With this configuration, even in cases where, for example, an ultrafine inorganic component having an average particle diameter of 0.3 μm or less is contained in the paste, it is possible to advantageously achieve the adhesion effect of the binder (D1) while limiting the usage quantity thereof.

<(D2) Organic Solvent>

The type etc. of the organic solvent (D2) is not particularly limited, and one or two or more types of commonly used organic solvent can be used as appropriate according to the intended use of the electrically conductive paste or the like. From perspectives such as workability during film formation and storage stability, an organic solvent having a high boiling point of 200° C. or higher, for example 200° C. to 300° C., may be used as a primary component (a component accounting for 50 vol % or more). Preferred examples of the organic solvent (D2) include hydroxy group-containing alcohol-based solvents such as terpineol, texanol, dihydroterpineol and benzyl alcohol; glycol-based solvents such as ethylene glycol and diethylene glycol; glycol ether-based solvents such as diethylene glycol monoethyl ether and butyl carbitol (diethylene glycol monobutyl ether); ester-based solvents having an ester bond group (R—C(═O)—O—R′), such as isobornyl acetate, ethyl diglycol acetate, butyl glycol acetate, butyl diglycol acetate, butyl cellosolve acetate and butyl carbitol acetate (diethylene glycol monobutyl ether acetate); hydrocarbon-based solvents such as toluene and xylene; and mineral spirits. Of these, alcohol-based solvents can be advantageously used.

The organic solvent (D2) content is not particularly limited, but if the overall amount of the electrically conductive paste is taken as 100 mass %, the organic solvent content may generally be 70 mass % or less, and is typically 5 to 60 mass %, for example 30 to 50 mass %. By falling within the range mentioned above, it is possible to impart the paste with a suitable fluidity and improve workability during film formation. In addition, it is possible to increase the self-leveling properties of the paste and provide a conductor film having a smoother surface.

<(E) Other Components>

The paste disclose here may be constituted only from components (A) to (D) described above, but may, if necessary, contain a variety of additives in addition to components (A) to (D). Components known as being able to be used in ordinary electrically conductive pastes can be used as appropriate as additional components as long as the advantageous effects of the features disclosed here are not significantly impaired.

Additional components are broadly divided into inorganic additives (E1) and organic additives (E2). Examples of the inorganic additives (E1) include sintering aids and inorganic fillers. An inorganic additive (E1) generally has an average particle diameter of approximately 10 nm to 10 μm, and preferably 0.3 μm or less from the perspective of lowering the arithmetic mean roughness Ra of a conductor film. Examples of the organic additives (E2) include leveling agents, anti-foaming agents, thickening agents, plasticizers, pH-adjusting agents, stabilizers, antioxidants, preservatives and coloring agents (pigments, dyes, and the like). An organic additive (E2) may, or may not, have an acid value. The additional components content is not particularly limited, but if the overall amount of the electrically conductive paste is taken as 100 mass %, the additional components content is generally 20 mass % or less, and is typically 10 mass % or less, for example 5 mass % or less.

The paste disclosed here is such that when the total acid value of the organic components per unit mass of the paste is taken as X and the total specific surface area of the inorganic components per unit mass of the paste is taken as Y, the (X/Y) ratio of the total acid value of the organic components relative to the total specific surface area of the inorganic components satisfy the following formula: 5.0×10⁻²≤(X/Y)≤6.0×10⁻¹. By satisfying the (X/Y) ratio mentioned above, the stability and integrity of the electrically conductive paste increase and favorable self-leveling properties can be exhibited. The value of X can be determined from formula (1) above. That is, the acid value for each organic component is determined from acid value (mg KOH/g)×content (mass %), and these values are totaled so as to obtain the value of X. For example, acid values are determined for the dispersing agent (C), the vehicle (D) and the organic additive (E2), which is used when necessary, and these values are totaled so as to obtain the value of X. In addition, the value of Y can be determined from formula (2) above. That is, the specific surface area for each inorganic component is determined from specific surface area (m²/g)×content (mass %), and these specific surface areas are totaled so as to obtain the value of Y. For example, the specific surface area is determined for the electrically conductive powder (A), the dielectric powder (B) and the inorganic additive (E1), which is used when necessary, and these specific surface areas are totaled so as to obtain the value of Y.

The (X/Y) ratio is generally 5.2×10⁻² or more and is, for example 6.5×10⁻² or more, such as 1.0×10⁻¹ or more. The (X/Y) ratio is generally 5.9×10⁻¹ or less and is, for example 5.1×10⁻¹ or less, such as 4.5×10⁻¹ or less or 3.5×10⁻¹ or less. By making the (X/Y) ratio fall within the range mentioned above, it is possible to significantly lower the arithmetic mean roughness Ra of a conductor film and stably provide a conductor filled having an arithmetic mean roughness Ra of, for example, 2.5 nm or less.

The value of X is not particularly limited, but is, per 100 g of paste, generally 10 mg KOH or more, for example 20 mg KOH or more, such as 30 mg KOH or more, and is generally 500 mg KOH or less, for example 300 mg KOH or less, such as 200 mg KOH or less. The value of Y is also not particularly limited, but is, per 100 g of paste, generally 100 m² or more, for example 200 m² or more, such as 250 m² or more, and is generally 700 m² or less, for example 500 m² or less, such as 400 m² or less.

This type of paste can be prepared by weighing out the materials mentioned above at prescribed content ratios (mass ratios) and then homogeneously mixing the materials by stirring. The materials can be stirred and mixed using a variety of conventional publicly known stirring and mixing apparatuses, such as a roller mill, a magnetic stirrer, a planetary mixer or a disper. In addition, the paste can be applied to a substrate using a printing method, such as screen printing, gravure printing, offset printing or inkjet printing, a spraying method, or the like. In applications where an internal electrode layer of a multilayer ceramic electrical component is to be formed, a gravure printing method is preferred from the perspective of enabling high speed printing.

According to the electrically conductive paste disclosed here, it is possible to form a conductor film having a high surface smoothness on a substrate. For example, it is possible to advantageously form a conductor film having an approximately flat surface, in which the arithmetic mean roughness Ra is lowered to 10 nm or less, preferably 5 nm or less, and more preferably 2.5 nm or less. In addition, according to the paste disclosed here, it is possible to improve the density of a conductor film beyond that of conventional films. For example, it is possible to advantageously form a compacted conductor film in which the density of the conductor film increases to 5.0 g/cm³ or more and preferably 5.3 g/cm³ or more, for example 5.0 to 6.0 g/cm³. Therefore, an electrode layer obtained by firing this conductor film can exhibit excellent electrical conductivity.

<Paste Applications>

The paste disclosed here can be advantageously used in applications in which surface smoothness of a conductor film is required. Typical examples include formation of internal electrode layers in multilayer ceramic electronic components. The paste disclosed here can be advantageously used to form an internal electrode layer of an ultra-small MLCC having sides measuring, for example, 5 mm or less, for example 1 mm or less. The term “ceramic electronic component” used herein is a general term meaning electronic components having a ceramic substrate such as a non-crystalline ceramic substrate (a glassy ceramic substrate) or a crystalline ceramic substrate (that is, non-glassy). For example, chip inductors having a ceramic substrate, high frequency filters, ceramic capacitors, low temperature co-fired ceramic substrates (LTCC substrates), high temperature co-fired ceramic substrate (HTCC substrates), and the like, are typical examples encompassed by the “ceramic electronic component” mentioned here.

Examples of ceramic materials that constitute ceramic substrates include oxide-based materials such as barium titanate (BaTiO₃), zirconium oxide (zirconia: ZrO₂), magnesium oxide (magnesia: MgO), aluminum oxide (alumina: Al₂O₃), silicon oxide (silica: SiO₂), zinc oxide (ZnO), titanium oxide (titania: TiO₂), cerium oxide (ceria: CeO₂) and yttrium oxide (yttria: Y₂O₃); composite oxide-based materials such as cordierite (2MgO.2Al₂O₃.5SiO₂), mullite (3Al₂O₃.2SiO₂), forsterite (2MgO.SiO₂), steatite (MgO.SiO₂), SiAlON (Si₃N₄—AlN—Al₂O₃), zircon (ZrO₂.SiO₂) and ferrite (M₂O.Fe₂O₃); nitrite-based materials such as silicon nitride (Si₃N₄) and aluminum nitride (AlN); carbide-based materials such as silicon carbide (SiC); hydroxide-based materials such as hydroxyapatite; elemental materials such as carbon (C) and silicon (Si); and inorganic composite materials containing two or more types of these.

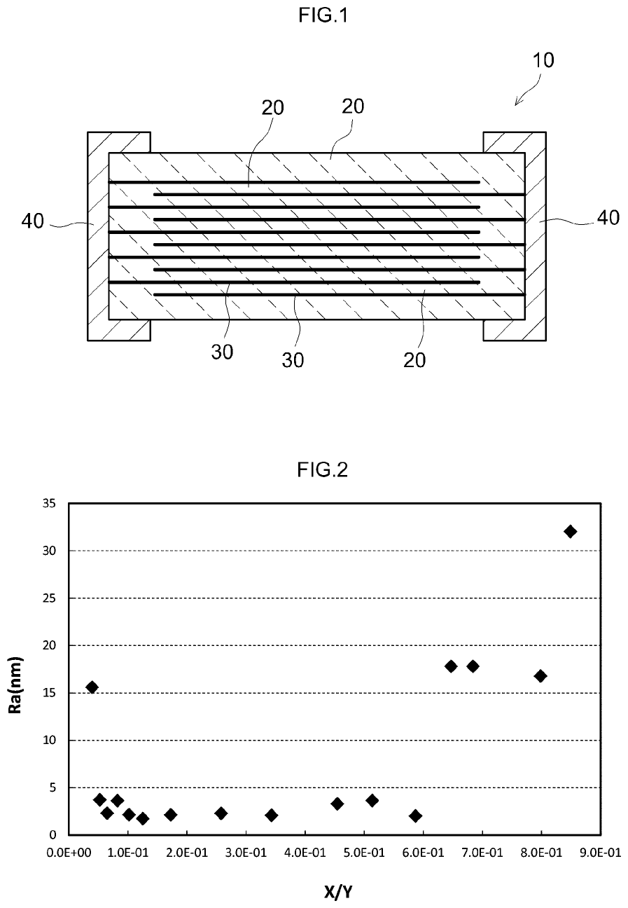

FIG. 1 is a cross-sectional view that schematically illustrates a multilayer ceramic capacitor (MLCC) 10. The MLCC 10 is a ceramic capacitor formed by alternately laminating a dielectric layer 20 and an internal electrode layer 30 many times. The dielectric layer 20 is constituted from, for example, a ceramic. The internal electrode layer 30 is constituted from a fired body of the electrically conductive paste disclosed here. The MLCC 10 is produced using, for example, the procedure described below.

That is, a ceramic green sheet is first prepared as a substrate. For example, a dielectric layer-forming paste is prepared by stirring and mixing a ceramic material as a dielectric material, a binder, an organic solvent, and the like. Next, a plurality of unfired ceramic green sheets are formed by spreading the prepared paste on a carrier sheet using a doctor blade method or the like. These ceramic green sheets are parts that serve as dielectric layers after firing.

The electrically conductive paste disclosed here is then prepared. Specifically, the electrically conductive paste is prepared by preparing at least the electrically conductive powder (A), the dielectric powder (B), the dispersing agent (C) and the vehicle (D), and stirring and mixing these so as to satisfy the (X/Y) ratio mentioned above. Next, conductor films are formed by applying the prepared paste to the plurality of thus formed ceramic green sheets so as to attain a prescribed pattern and a desired thickness (for example, the sub-micron to micron level). These conductor films are parts that serve as internal electrode layers after firing.

After preparing a plurality (for example several hundred to several thousand) of these thus obtained ceramic green sheets equipped with unfired conductor films, these are laminated and pressure bonded. An unfired multilayer chip is prepared in this way.

Next, the thus prepared unfired multilayer chip is fired under suitable heating conditions (for example, a temperature of approximately 1000° C. to 1300° C.). In this way, the multilayer chip is simultaneously fired (baked) and integrally sintered. In this way, it is possible to obtain a composite material in which the dielectric layer 20 and internal electrode layer 30 are alternately laminated many times. Finally, an external electrode 40 is formed by coating an electrode material on a cross section of the fired composite material and then baking. The MLCC 10 can be prepared in this way.

A number of working examples relating to the present invention will now be explained, but the present invention is in no way limited to these working examples.

First, electrically conductive pastes (Examples 1 to 11 and Comparative Examples 1 to 5) were prepared by mixing electrically conductive particles, dielectric particles, a dispersing agent and a vehicle at the quantities shown in Table 1. In the electrically conductive pastes disclosed here, the inorganic components are an electrically conductive powder and a dielectric powder. The organic components are a dispersing agent and a vehicle (a binder and an organic solvent).

The weight average molecular weight Mw of the carboxylic acid-based dispersing agent A was 500, the weight average molecular weight Mw of the amine-based dispersing agent B was 400, and the weight average molecular weight Mw of the dicarboxylic acid-based dispersing agent C was 14,000. In addition, the binder (ethyl cellulose) was a mixture of types having different weight average molecular weights Mw, with the lowest weight average molecular weight Mw being 80,000 and the weight average molecular weight Mw of the component present at the highest proportion in terms of mass (the primary binder) being 180,000.

In addition, “Ni powder” in Table 1 indicates a nickel powder. A powder having an average particle diameter of 0.1 to 0.3 μm (manufacturer's nominal value; number-based average particle diameter determined by means of electron microscope observations) was used as the nickel powder. In addition, “BT powder” in Table 1 means a barium titanate powder. A powder having an average particle diameter of 10 to 100 nm (manufacturer's nominal value; number-based average particle diameter determined by means of electron microscope observations) was used as the barium titanate powder.

Next, the (X/Y) ratio was calculated using formulae (1) and (2) described above (a).

In addition, the electrically conductive paste was coated on a glass substrate using an applicator or the like and dried for 10 minutes at 100° C. so as to form a conductor film having a thickness of approximately 1 μm, and the surface roughness was evaluated (b) and the conductor film density was evaluated (c).

(a) Calculation of (X/Y) Ratio

Value of X

First, the acid values of the organic components, that is, the dispersing agents A to C, the binder and the organic solvent were measured using a potentiometric titration method in accordance with JIS K0070:1992. These results are also shown in Table 1. In cases where measured results were below measurement lower limits, “no acid value” was recorded in the table. Next, the acid values for each example were determined from acid value (mg KOH/g) of each component x content (mass %), and these values were totaled to calculate the total acid value X of organic components in 100 g of the paste. These results are shown in Table 1. Because the binder and organic solvent do not have an acid value, the acid values of the dispersing agents were the same as the total acid value X of organic components in 100 g of the paste.

Value of Y

First, the specific surface areas of the inorganic components, that is, the nickel powders A to E and the BT powders A to E, were measured using a nitrogen gas adsorption method (a constant volume method) and analyzed using the BET method. These results are also shown in Table 1. Next, the specific surface area (total area) of nickel powder in 100 g of paste was determined for each example from specific surface area (m²/g) of nickel powder×nickel powder content (mass %). Similarly, the specific surface area (total area) of barium titanate powder in 100 g of paste was determined for each example from specific surface area (m²/g) of barium titanate powder×barium titanate powder content (mass %). Next, the specific surface area of nickel powder and the specific surface area of barium titanate powder in 100 g of paste were totaled, and the total specific surface area Y of inorganic components in 100 g of paste was calculated. These results are shown in Table 1.

Value of X/Y

The (X/Y) ratio was calculated by dividing the total acid value X of organic components in 100 g of paste by the total specific surface area Y of inorganic components in 100 g of paste. These results are shown in Table 1.

(b) Evaluation of Surface Roughness

The surface smoothness (arithmetic mean roughness Ra) of a conductor film was calculated under the conditions described below using an interference microscope. These results are shown in Table 1.

Apparatus: BW-A501 ultrahigh resolution non-contact three-dimensional surface profile measurement system (available from Nikon Corporation)

LV-150 optical microscope (available from Nikon Corporation) Magnification: 100 times, operating width: ±5 μm, measurement range: 50 μm×1000 μm

(c) Evaluation of Conductor Film Density

The weight and thickness of a conductor film were measured, and the conductor film density was calculated from the following formula (3): Conductor film density (g/cm³)=weight (g) of conductor film/apparent volume (cm³) of conductor film. These results are shown in Table 1.

TABLE 1

| Paste composition | | | | | | Comparative | | | | |
|---|---|---|---|---|---|---|---|---|---|---|
| (mass %) | | Example 1 | Example 2 | Example 3 | Example 4 | Example 1 | Example 5 | Example 6 | Example 7 | Example 8 |
| Electrically | Ni powder A (BET | 50 | 50 | 50 | 50 | — | — | — | — | — |
| conductive | specific surface | | | | | | | | | |
| particles | area: 2.8 m²/g) | | | | | | | | | |
| | Ni powder B (BET | — | — | — | — | 46 | 46 | — | — | — |
| | specific surface | | | | | | | | | |
| | area: 3.7 m²/g) | | | | | | | | | |
| | Ni powder C (BET | — | — | — | — | — | — | 50 | 50 | 50 |
| | specific surface | | | | | | | | | |
| | area: 3.6 m²/g) | | | | | | | | | |
| | Ni powder D (BET | | — | — | — | — | — | — | — | — |
| | specific surface | | | | | | | | | |
| | area: 3.7 m²/g) | | | | | | | | | |
| | Ni powder E (BET | — | — | — | — | — | — | — | — | — |
| | specific surface | | | | | | | | | |
| | area: 5.1 m²/g) | | | | | | | | | |
| Dielectric | BT powder A | — | — | — | — | 11.6 | 11.6 | | | |
| particles | (BET specific | | | | | | | | | |
| | surface area: 10.5 | | | | | | | | | |
| | m²/g) | | | | | | | | | |
| | BT powder B | — | — | — | — | — | — | 7.5 | 7.5 | 7.5 |
| | (BET specific | | | | | | | | | |
| | surface area: 15.9 | | | | | | | | | |
| | m²/g) | | | | | | | | | |
| | BT powder C | 2.5 | 5.0 | 7.5 | 12.5 | — | — | — | — | — |
| | (BET specific | | | | | | | | | |
| | surface area: 21.0 | | | | | | | | | |
| | m²/g) | | | | | | | | | |
| | BT powder D | — | — | — | — | — | — | — | — | — |
| | (BET specific | | | | | | | | | |
| | surface area: 30.0 | | | | | | | | | |
| | m²/g) | | | | | | | | | |
| | BT powder E | — | — | — | — | — | — | — | — | — |
| | (BET specific | | | | | | | | | |
| | surface area: 62.0 | | | | | | | | | |
| | m²/g) | | | | | | | | | |
| Dispersing | Carboxylic | 0.16 | 0.32 | 0.48 | 0.80 | 0.30 | 0.30 | 0.55 | 0.55 | 0.55 |
| agent | acid-based | | | | | | | | | |
| | dispersing agent A | | | | | | | | | |
| | (acid value: 63 mg | | | | | | | | | |
| | KOH/g) | | | | | | | | | |
| | Amine-based | — | — | — | — | 0.40 | 0.40 | 0.30 | 0.30 | 0.30 |
| | dispersing agent B | | | | | | | | | |
| | (no acid value) | | | | | | | | | |
| | Dicarboxylic | — | — | — | — | 1.00 | — | 0.10 | 0.25 | 0.40 |
| | acid-based | | | | | | | | | |
| | dispersing agent C | | | | | | | | | |
| | (acid value: 170 | | | | | | | | | |
| | mg KOH/g) | | | | | | | | | |
| Vehicle | Binder (ethyl | 2.3 | 2.3 | 2.3 | 2.3 | 2.8 | 2.8 | 2.0 | 2.0 | 2.0 |
| | cellulose (no acid | | | | | | | | | |
| | value)) | | | | | | | | | |
| | Organic solvent | 45.0 | 42.4 | 39.7 | 34.4 | 37.9 | 38.9 | 39.6 | 39.4 | 39.3 |
| | (dihydroterpineol | | | | | | | | | |
| | (no acid value)) | | | | | | | | | |

| | | | | | | | | | |
|---|---|---|---|---|---|---|---|---|---|
| Total | 100.0 | 100.0 | 100.0 | 100.0 | 100.0 | 100.0 | 100.0 | 100.0 | 100.0 |
| Surface roughness Ra (nm) | 3.72 | 3.63 | 2.15 | 1.73 | 17.80 | 2.30 | 2.13 | 2.28 | 2.08 |
| of dry film | | | | | | | | | |
| Total acid value X (mg | 10.08 | 20.16 | 30.24 | 50.40 | 188.90 | 18.90 | 51.65 | 77.15 | 102.65 |
| KOH) of organic | | | | | | | | | |
| components in 100 g of paste | | | | | | | | | |
| Total area (m²) of Ni powder | 140 | 140 | 140 | 140 | 170 | 170 | 180 | 180 | 180 |
| in 100 g of paste | | | | | | | | | |
| Total area (m²) of BT | 53 | 105 | 158 | 263 | 122 | 122 | 119 | 119 | 119 |
| powder in 100 g of paste | | | | | | | | | |
| Total specific surface area Y | 193 | 245 | 298 | 403 | 292 | 292 | 299 | 299 | 299 |
| (m²) of inorganic | | | | | | | | | |
| components in 100 g of paste | | | | | | | | | |
| Total acid value/total area | 5.2 × | 8.2 × | 1.0 × | 1.3 × | 6.5 × | 6.5 × | 1.7 × | 2.6 × | 3.4 × |
| (X/Y) | 10⁻² | 10⁻² | 10⁻¹ | 10⁻¹ | 10⁻¹ | 10⁻² | 10⁻¹ | 10⁻¹ | 10⁻¹ |
| Electrically conductive film | 5.44 | 5.60 | 5.68 | 5.57 | 5.00 | 5.00 | 5.31 | 5.38 | 5.32 |
| density (g/cm³) | | | | | | | | | |

| Paste composition | | | Comparative | Comparative | Comparative | | Comparative | |
|---|---|---|---|---|---|---|---|---|
| (mass %) | | Example 9 | Example 2 | Example 3 | Example 4 | Example 10 | Example 5 | Example 11 |
| Electrically | Ni powder A (BET | — | — | — | — | — | — | — |
| conductive | specific surface | | | | | | | |
| particles | area: 2.8 m²/g) | | | | | | | |
| | Ni powder B (BET | — | — | — | — | — | — | — |
| | specific surface | | | | | | | |
| | area: 3.7 m²/g) | | | | | | | |
| | Ni powder C (BET | 50 | 50 | — | — | — | — | — |
| | specific surface | | | | | | | |
| | area: 3.6 m²/g) | | | | | | | |
| | Ni powder D (BET | — | — | 45 | 45 | 45 | — | — |
| | specific surface | | | | | | | |
| | area: 3.7 m²/g) | | | | | | | |
| | Ni powder E (BET | — | — | — | — | — | 45 | 45 |
| | specific surface | | | | | | | |
| | area: 5.1 m²/g) | | | | | | | |
| Dielectric | BT powder A | | | — | — | — | — | — |
| particles | (BET specific | | | | | | | |
| | surface area: 10.5 | | | | | | | |
| | m²/g) | | | | | | | |
| | BT powder B | 7.5 | 7.5 | — | — | — | — | — |
| | (BET specific | | | | | | | |
| | surface area: 15.9 | | | | | | | |
| | m²/g) | | | | | | | |
| | BT powder C | — | — | — | — | — | — | — |
| | (BET specific | | | | | | | |
| | surface area: 21.0 | | | | | | | |
| | m²/g) | | | | | | | |
| | BT powder D | — | — | 6.8 | 6.8 | — | 6.8 | — |
| | (BET specific | | | | | | | |
| | surface area: 30.0 | | | | | | | |
| | m²/g) | | | | | | | |
| | BT powder E | — | — | — | — | 6.8 | — | 6.8 |
| | (BET specific | | | | | | | |
| | surface area: 62.0 | | | | | | | |
| | m²/g) | | | | | | | |
| Dispersing | Carboxylic | 0.55 | 0.55 | 0.27 | 0.27 | 0.27 | 0.27 | 0.27 |
| agent | acid-based | | | | | | | |
| | dispersing agent A | | | | | | | |
| | (acid value: 63 mg | | | | | | | |
| | KOH/g) | | | | | | | |
| | Amine-based | 0.30 | 0.30 | 0.45 | 0.45 | 0.45 | 0.45 | 0.45 |
| | dispersing agent B | | | | | | | |
| | (no acid value) | | | | | | | |
| | Dicarboxylic | 0.70 | 1.00 | 1.75 | 1.64 | 1.93 | — | 1.64 |
| | acid-based | | | | | | | |
| | dispersing agent C | | | | | | | |
| | (acid value: 170 | | | | | | | |
| | mg KOH/g) | | | | | | | |
| Vehicle | Binder (ethyl | 2.0 | 2.0 | 2.0 | 2.7 | 1.5 | 1.4 | 1.4 |
| | cellulose (no acid | | | | | | | |
| | value)) | | | | | | | |
| | Organic solvent | 39.0 | 38.7 | 43.7 | 43.1 | 44.1 | 46.1 | 44.4 |
| | (dihydroterpineol | | | | | | | |
| | (no acid value)) | | | | | | | |

| | | | | | | | |
|---|---|---|---|---|---|---|---|
| Total | 100.0 | 100.0 | 100.0 | 100.0 | 100.0 | 100.0 | 100.0 |
| Surface roughness Ra (nm) | 3.65 | 17.80 | 32.03 | 16.78 | 2.02 | 15.60 | 3.30 |
| of dry film | | | | | | | |
| Total acid value X (mg | 153.65 | 204.65 | 314.51 | 295.81 | 345.11 | 17.01 | 295.81 |
| KOH) of organic | | | | | | | |
| components in 100 g of paste | | | | | | | |
| Total area (m²) of Ni powder | 180 | 180 | 167 | 167 | 167 | 230 | 230 |
| in 100 g of paste | | | | | | | |
| Total area (m²) of BT | 119 | 119 | 204 | 204 | 422 | 204 | 422 |
| powder in 100 g of paste | | | | | | | |
| Total specific surface area Y | 299 | 299 | 371 | 371 | 588 | 434 | 651 |
| (m²) of inorganic | | | | | | | |
| components in 100 g of paste | | | | | | | |
| Total acid value/total area | 5.1 × | 6.8 × | 8.5 × | 8.0 × | 5.9 × | 3.9 × | 4.5 × |
| (X/Y) | 10⁻¹ | 10⁻¹ | 10⁻¹ | 10⁻¹ | 10⁻¹ | 10⁻² | 10⁻¹ |
| Electrically conductive film | 5.28 | 5.19 | 5.61 | 5.57 | 5.18 | 5.56 | 5.12 |
| density (g/cm³) | | | | | | | |

FIG. 2 is a graph that shows the relationship between the value of X/Y and the value of Ra. As shown in Table 1 and FIG. 2, Comparative Examples 1 to 4 had an arithmetic mean roughness Ra of 16 nm or more, and had significant unevenness on a conductor film surface. The reason for this is not clear, but it is thought that self-leveling properties deteriorated because the total acid value X of organic components relative to the total specific surface area Y of inorganic components was excessively high.

In addition, Comparative Example 5 had an arithmetic mean roughness Ra of 15.6 nm, and had significant unevenness on a conductor film surface. The reason for this is not clear, but it is thought that affinity between inorganic components and organic components decreased and phase separation occurred in the conductor film because the total acid value X of organic components relative to the total specific surface area Y of inorganic components was insufficient.

Unlike these comparative examples, the arithmetic mean roughness Ra of a conductor film was lowered such that Ra≤5 nm in Examples 1 to 11, in which the (X/Y) ratio satisfied the requirement of 5.0×10⁻² to 6.0×10⁻¹. Among these examples, the arithmetic mean roughness Ra of a conductor film was lowered such that Ra 2.5 nm in Examples 3, 4, 5 to 8 and 10. Therefore, according to the electrically conductive paste disclosed here, it is possible to form a conductor film having a high surface smoothness (for example, an arithmetic mean roughness Ra of 5 nm or less).

The present invention has been explained in detail above, but these are merely examples, and the present invention can be variously modified as long as these modifications do not depart from the gist of the present invention.

### REFERENCE SIGNS LIST

10 Multilayer ceramic capacitor
20 Ceramic green sheet
30 Internal electrode layer
40 External electrode

1. An electrically conductive paste for forming a conductor film comprising:
inorganic components including an electrically conductive powder and a dielectric powder; and
organic components including a dispersing agent and a vehicle; the dispersing agent including a dispersing agent having an acid value;
wherein, when the total acid value of the organic components per unit mass of the electrically conductive paste is taken as X (mg KOH) and the total specific surface area of the inorganic components per unit mass of the electrically conductive paste is taken as Y (m²), the X and the Y satisfy the following formula: 5.0×10⁻²≤(X/Y)≤6.0×10⁻¹.

2. The electrically conductive paste according to claim 1, wherein each inorganic component has a number-based average particle diameter of 0.3 μm or less, as determined based on electron microscope observations.

3. The electrically conductive paste according to claim 1, wherein the amount of the dispersing agent is 3 mass % or less relative to 100 mass % as the overall amount of the electrically conductive paste.

4. The electrically conductive paste according to claim 1, wherein the electrically conductive powder is at least one of nickel, platinum, palladium, silver and copper.

5. (canceled)

6. The electrically conductive paste according to claim 1, wherein the Y is 299 m² or less per 100 g of the electrically conductive paste.

7. The electrically conductive paste according to claim 1, wherein a weight average molecular weight of the dispersing agent, which is measured by means of gel permeation chromatography and is a weight-based average molecular weight calculated using a standard polystyrene calibration curve, is 500 or more.

8. The electrically conductive paste according to claim 7, wherein the dispersing agent includes a carboxylic acid-based dispersing agent.

9. The electrically conductive paste according to claim 1, wherein the contents of the dielectric powder is 3 parts by mass or more and 25 parts by mass or less relative to 100 parts by mass of the electrically conductive powder.

10. A conductive film formed by the electrically conductive paste according to claim 1, wherein the conductor film defines a conductor film density exceeding 5.0 g/cm³.

11. The electrically conductive paste according to claim 2, wherein the amount of the dispersing agent is 3 mass % or less relative to 100 mass % as the overall amount of the electrically conductive paste.

12. The electrically conductive paste according to claim 2, wherein the electrically conductive powder is at least one of nickel, platinum, palladium, silver and copper.

13. The electrically conductive paste according to claim 3, wherein the electrically conductive powder is at least one of nickel, platinum, palladium, silver and copper.

14. The electrically conductive paste according to claim 1, configured to form the conductor film having a conductor film density exceeding 5.0 g/cm³.
